(19) United States
(12) Patent Application Publication
(10) Pub. No.: US 2019/0072441 A1
(43) Pub. Date: Mar. 7, 2019

(54) DIGITAL CREEP AND DRIFT CORRECTION

(71) Applicant: XYZTEC B.V. [NL/NL], Panningen (NL)

(72) Inventor: Robert John SYKES, Panningen (NL)

(21) Appl. No.: 16/079,776

(22) PCT Filed: Feb. 10, 2017
(86) PCT No.: PCT/NL2017/050081

§ 371 Date: Aug. 24, 2018

(30) Foreign Application Priority Data
Feb. 24, 2016 (NL) 2016315

(51) Int. Cl. G01L 1/22; G01L 5/00; G06F 17/11

(52) U.S. Cl. CPC G01L 1/2268; G06F 17/11; G01L 5/0028

(57) ABSTRACT

Sensor apparatus for determining a deformation due to creep in an output of a sensor, said sensor apparatus comprising force means arranged for applying a mechanical force to said sensor, said sensor arranged for measuring, in a current measurement, a displacement of said sensor caused by said applied force and a processor component arranged for determining said deformation due to creep for a next measurement by said sensor.

Force measurement is often achieved by measuring the deformation of an elastic element where the deformation is some function of said force. A known problem exists where the deformation is not only a function of the force but also a function of how long the force is applied. The magnitude of the change in deformation due to time is in most cases much less than that caused by the initial deformation when the force is applied but in many cases it will affect the accuracy of a force measurement if the function relating deformation to force does not include how it is affected by time. Such time dependant deformation is commonly known as creep. This invention is for a method that enables the effect of creep in a deformation force measurement system to be accounted for and thereby improving the force measurement accuracy.

Methods that account for creep are known but these require hardware that is characterised to have a reverse effect to the creep such that the sum of output and the characterised correction is creep free. Whilst this does offer improvement it is limited to the accuracy of the characterisation in its design and manufacturing consistency. This type of correction is known in the art of designing and applying strain gauges. Some methods convert the force measurement into a digital signal and apply algorithms that include time to make the correction. Such methods though do not allow, or adequately allow, for forces that are continually changing; accounting for creep with a static force being much easier than a force that changes. Part of this invention is for a specific method that uses an algorithm that can more accurately correct for creep in all cases and including where the force changes.

In accordance with a first aspect, the invention provides a method of determining a deformation due to creep in an output of a sensor, comprised by a sensor apparatus, which sensor is measuring a mechanical force, said method comprising the steps of:
applying a mechanical force to said sensor;
measuring, in a current measurement, by said sensor, a displacement of said sensor caused by said applied force;
determining, by a processor component comprised by said sensor apparatus, said deformation due to creep for a next measurement by said sensor, by:
   providing a creep function, wherein said creep function defines said deformation due to creep over time;
   calculating said deformation due to creep for a next measurement, based on:
      said creep function;
      a time between:
      c) said current measurement of said sensor, and
      d) said next measurement;
      wherein said time between said current and said next measurement is a small proportion of an overall said measurement time. Said measurement time being typically 1/50 or less than said overall measurement time. In many cases the overall measurement time is continuous and the said time between measurements then goes towards 1/infinity.
      said measured applied force in said current measurement;
      a deformation due to creep in said current measurement.

It was the insight of the inventor that the deformation due to creep can be determined as the creep function can be estimated or determined beforehand. When the creep function is known, an estimate can be provided for the deformation due to creep when the four variables are known, i.e. the creep function, the time between the current measurement of the sensor component and the next measurement, the measured applied force in the current measurement and the deformation due to creep in the current measurement.

Based on these aspects, the deformation due to creep can be determined for a next measurement.

In a beneficial aspect of the invention, the creep function is an exponential function which further depends on the initially applied force. As long as the creep function is known, and it is known where you are at the creep function with respect to time, then the creep can be determined.

In a further aspect, the invention provides a method for determining an applied mechanical force using an output of a sensor which is measuring said applied mechanical force and in which is said sensor is exposed to a drifting error, said method being performed by a sensor apparatus, said method comprising the subsequent steps of:
measuring, in a first measurement, by said sensor of said sensor apparatus, said applied force when no force is applied;
nulling, by a processor component comprised by said sensor apparatus, said measured applied force in said first measurement;
applying a mechanical force to said sensor;
measuring, in a second measurement, by said sensor by said sensor apparatus, said applied force;
stop applying said mechanical force to said sensor;
measuring, in a third measurement, by said sensor, said applied force when no force is applied to said sensor;
nulling, by said processor component, said measured applied force in said third measurement, therewith obtaining a drifting error that occurred between said first and third measurement;
correcting said second measurement by an interpolated value, said interpolated value being provided by interpolating, by said processor component, the obtained drifting error between said first measurement and said third measurement for said second measurement.

The inventor has found that the output of the sensor may drift over time. Here, the drifting error is determined in the first and the third measurement. The drifting error can be determined in the first and the third measurement as there is no applied force to the sensor at these moments. The drifting error is then interpolated, and the second measurement, i.e. the measurement when a force is applied, is corrected by means of the interpolated drifting error. Multiple second measurements may be taken when an applied force is being measured over a period of time.

Features of the invention will be apparent from the following description with reference to the accompanying drawings in which:

FIG. 1 shows a graphical representation of positive creep

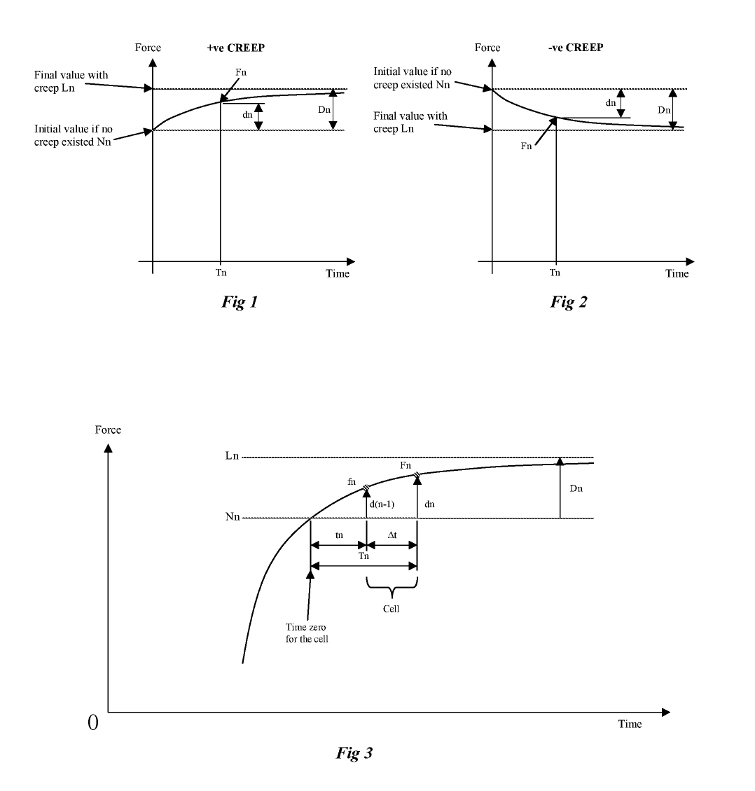

FIG. 2 shows a graphical representation of negative creep

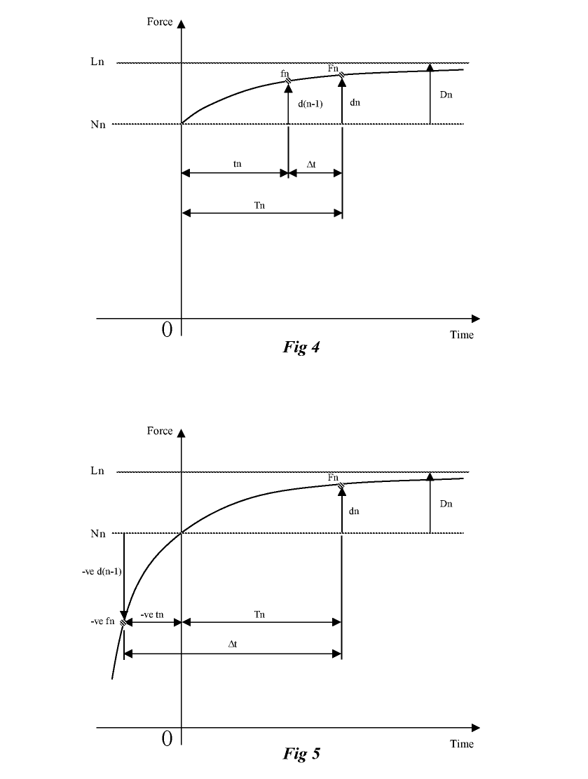

FIG. 3 shows a graphical representation for the calculation of the creep at any one measurement.

FIG. 4 shows the same graphical representation as FIG. 3 but where the “time zero” for the measurements is normalised about the time axis equal to zero.

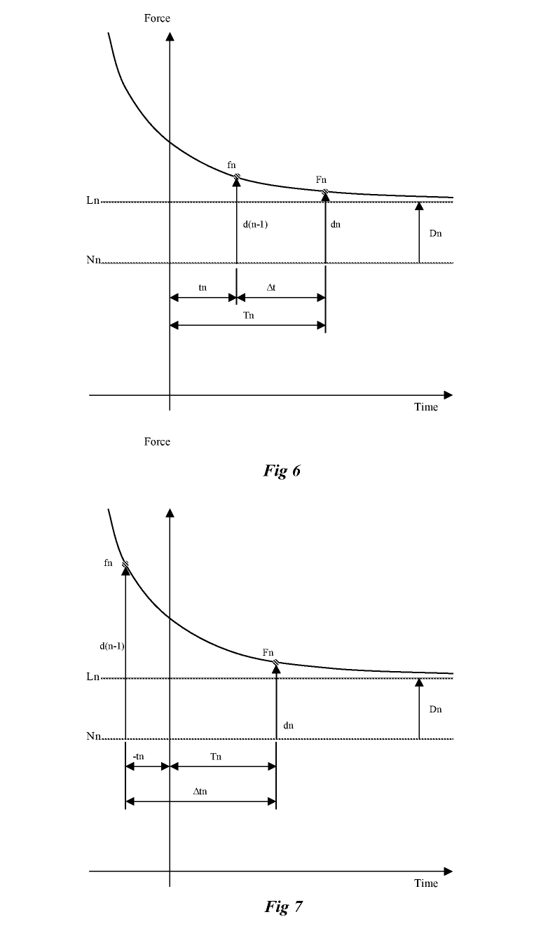

FIG. 5 shows a similar case to FIG. 4 but where the creep from the previous measurement is negative.

FIG. 6 shows another case similar to FIG. 3 but where the creep decreases

FIG. 7 shows a similar case to FIG. 6 but where the creep in the previous measurement is greater than that which would occur at time zero.

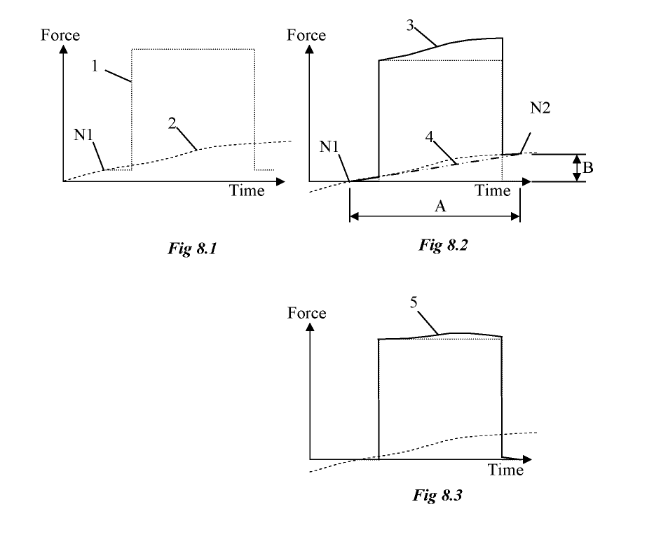

FIGS. 8.1, 8.2 and 8.3 show graphical illustrations of the drift correction method.

The method of the invention requires the nature of creep to be defined and calibrated. FIG. 1 is a graphical representation of a force sensors output subjected to the instant application of a constant force. The measured force Fn rises to Nn when the force is applied and then creeps by some function of time towards Ln. In the method Dn is defined to be in direct proportion to the initial force Nn, such that,

Dₙ=RNₙ

### Where,

R=the creep constant (is defined as the creep constant)
In some force measurement systems creep is negative, as represented graphically in FIG. 2. The characteristics of this are the same as positive creep except that after the forces initial rise to Nn it then falls towards Ln. Negative creep occurs in complex structures where a part of the deformation measurement system creeps more and in an opposite direction to the creep in its main part. Consequently despite a gross positive deformation the creep is negative. This behaviour can be seen in some load cells that use strain gauges. In the method negative creep is defined by a negative value for R.
If the applied load Nn is negative and R is positive Dn will be negative so the creep increases negatively. This is the “mirror image” about the horizontal axis in FIG. 1 of the graph of positive creep and means the magnitude of the deformation will increase over time. If the applied load Nn is negative and R is negative the magnitude of creep will decrease, the mirror image of negative creep.
The correction method works from a starting condition where the force sensor has had no load acting on it for sufficient time such that any creep can be assumed to be negligible and equal to zero. Sensor deformation is measured and represented in numeric form. The sensors deformation being taken at set time intervals of Δt. Random time intervals of known values are also possible but not preferred.

The time between a current measurement and the one that preceded it is referred to as a “cell”. FIG. 3 is the graphic representation of a cell where the current deformation is fn and includes the current creep d(n−1). The creep dn in the current cell is calculated from the creep of the previous cell d(n−1) plus that which will occur in the current one. To do this we have to calculate a creep curve we are on, which has the equivalent initial force Nn, current creep d(n−1) and current deformation fn. The initial force Nn for each cell is an equivalent initial load where the creep would be zero and then built up to fn in time tn. Once we have Nn and tn we can calculate the creep in the cell from the time tn+Δt=Tn. The solutions for Nn, tn and dn are derived from the creep function. As the previous creep d(n−1) and current deformation fn are known the values of Nn and then dn can be solved.

FIG. 3 illustrates how the equivalent creep curve for any cell can occupy many places in the absolute force time graph where time started with zero creep. FIG. 4 normalises the same equivalent creep curve around its own time zero where deformation fn occurs at tn from time equal to zero. It is possible though that d(n−1) may be negative, as illustrated graphically in FIG. 5. In a correct solution of the creep time function such events will “take care of themselves”, that is to say entering a negative term for d(n−1) will lead to a negative time tn. In both FIG. 4 and FIG. 5 the creep is increasing. There is also the possibility that the creep may decrease in a cell. This occurs when d(n−1) is larger than the difference between Ln and Nn as illustrated in FIG. 6. Again tn may be negative as illustrated in FIG. 7.

The possible examples shown in FIGS. 4, 5, 6 and 7 are for cases where fn is positive. When fn is negative similar cases can occur where the illustration would be mirrored about the time axis of the graph and the signs of the terms reversed. The examples in FIGS. 4, 5, 6 and 7 also show the case with a positive creep characteristic. Similar examples exist for negative creep as initially shown in FIG. 2. In all cases entering the correct signs, positive or negative, for the terms in a correct solution of the creep time function will result in the correct calculation of dn.

If due to creep, the deformation of the sensor is time dependant we have to consider what is the correct deformation, or in other words, the “True” sensor output. From the correction method we have two values Nn and Ln. Nn is the value that the deformation would be at the current point in time if the sensor did not creep. Ln is the value the deformation would be if all the creep at the current point in time had, had time to reach equilibrium. Both Nn and Ln can then be used as values where creep has been accounted for. In a preferred embodiment, for ease of calibrating the sensor, Ln would be used. To calibrate a sensor a known load has to be applied. If a known load is applied rapidly, such that it approximates to instantly, the sensor deformation or output will rise initially to Nn and then if the load is held, the deformation will change under the influence of creep to towards Ln. If the load is held for sufficient time such that the deformation approximates to a constant value both Ln and the creep characteristic can be calibrated. A common problem of using Nn would be when weights are used to apply the known load. In such cases the application of the weight requires accelerations that change the load at the instant of application and hence the instantaneous load is not Nn.

In a preferred embodiment the nature of the creep is defined in the method as being exponential but reasonable corrections are possible with other functions that closely resemble the creep characteristic. In the preferred embodiment the expression for the creep characteristic is then,

dₙ=Dₙ(1−e^{-Tn/τ})

### Where,

dn=The creep at time Tn
Dn=The total creep at time infinity
τ=The creep time constant
In the method the creep characteristic is then defined by the two constants τ and R. A full solution of an exponential characteristic applied to creep using the symbolic representations in FIGS. 1 to 7 result in the following expressions,

### If

$$( 1 - \frac{{d}_{( n - 1 )}}{R ( {f}_{n} - {f}_{( n - 1 )} )} ) = 0$$

$${d}_{n} = {d}_{( n - 1 )}$$

$$If \\ ( 1 - \frac{{d}_{( n - 1 )}}{R ( {f}_{n} - {f}_{( n - 1 )} )} ) > 0$$

$${d}_{n} = R ( {f}_{n} - {d}_{( n - 1 )} ) ( 1 - {e}^{( ln \vert 1 - \frac{{d}_{( n - 1 )}}{R ( {f}_{n} - {f}_{( n - 1 )} )} \vert - \frac{Δ t}{T} )} )$$

$$If \\ ( 1 - \frac{{d}_{( n - 1 )}}{R ( {f}_{n} - {f}_{( n - 1 )} )} ) < 0$$

$${d}_{n} = R ( {f}_{n} - {d}_{( n - 1 )} ) ( 1 + {e}^{( ln \vert 1 - \frac{{d}_{( n - 1 )}}{R ( {f}_{n} - {f}_{( n - 1 )} )} \vert - \frac{Δ t}{T} )} )$$

$$And$$

$${L}_{n} = ( 1 + R ) ( {f}_{n} - {d}_{( n - 1 )} )$$

It can be seen that the value of dn depends on the “state”, of

$$( 1 - \frac{{d}_{( n - 1 )}}{R ( {f}_{n} - {f}_{( n - 1 )} )} ) = 0$$

This is explained by the different states of the creep in the previous measurement as discussed with reference to FIGS. 4, 5, 6, and 7. Also as previously mentioned, the need to find out the current “state” becomes apparent in the correct solution to the assumed creep function, which in this case is exponential.

Knowing Δt, R, τ, fn and d(n−1) these expressions can be used to calculate dn and Ln for any cell.

Δt is the time between the current and next cell. In a preferred embodiment Δt is constant for all cells.

fn and d(n−1) are the current deformation and previous creep respectively. R and τ are calculated from a calibration symbolised in FIG. 1 or FIG. 2 dependent on type of creep characteristic by the following expressions

$$R = \frac{Ln - Nn}{Nn}$$

$$τ = \frac{- {T}_{n}}{ln ( \frac{Ln - {F}_{n}}{Ln - Nn} )}$$

Alternatively R and τ can be found by trial and error with reference to a known loading condition.

Another aspect of the invention is the minimization of drift. Errors in the output of force measurement systems can come from many sources. Some errors like creep can be reduced. Another common cause of error results from variations in temperature. The effects of temperature can, and often are, accounted for and reduced. Other sources of error may be unknown and those accounted for can only be reduced; they cannot be eliminated. If a sensor is left without any load on it and the zero output recorded one will have variations. This variation is referred to as null drift, (null being the output with no load), and is the second aspect of the invention. Null drift also changes the output with a load applied by a similar amount. One method of reducing the effect of null drift is well known and sometimes referred to as “a tare”. A common example is when the no load output of a weighing device is set to zero. This eliminates the null error when the weight is then applied. This method eliminates any null error at the time when it is done but null drift can continue from that point and error is once again introduced. This invention is for a method of taking two nulls, as will be demonstrated with reference to FIG. 8.

FIG. 8.1 illustrates a rapidly applied constant load 1, which is then held for a time and then rapidly removed. The principle applies equally to any load time function but this “step input” shape illustrated helps in the explanation. If the load were not applied the null output of the sensor would drift as illustrate by line 2. As is already known to the skilled person the sensor output can be nulled at N1 eliminating the error at that point in time. In this example the drift continues such that it significantly affects the sensor output during the load application. The effect on the load is shown in FIG. 8.2 as line 3. Although the null error was initially eliminated at N1 by re-zeroing the sensor, the drift continues to affect the sensor output thought the load application. The method of the invention is to take a second null N2 after the load application. In the illustration the magnitude of the null error at N2 is B. This error is then subtracted from the sensor output at this point and in linear proportion to line 4 at all points of the output up to N1 where the null error will already be zero. The effect of subtracting the null error in proportion to the two nulls N1 and N2 is illustrated as line 5 in FIG. 8.3. Any drift that is none linear between the two null points is not corrected but any gross change and its linear component is corrected. Whilst line 5 is not exactly like the true load application 1, it is a closer representation.

The two parts of this invention can be applied either separately or jointly. In a preferred embodiment the creep correction is applied first and then the drift correction.

1. A sensor apparatus for determining a deformation due to creep in an output of a sensor, said sensor apparatus comprising:
force means arranged for applying a mechanical force to said sensor;
said sensor arranged for measuring, in a current measurement, a displacement of said sensor caused by said applied force;
a processor component arranged for determining said deformation due to creep for a next measurement by said sensor, by:
providing a creep function, wherein said creep function defines said deformation due to creep over time;
calculating said deformation due to creep for a next measurement, based on:
said creep function;
a time between:
said current measurement of said sensor and
said next measurement;
wherein said time between said current and said next measurement is a small portion of an overall measurement time;
said measured applied force in said current measurement;
a deformation due to creep in said current measurement.

2. The sensor apparatus for determining a deformation due to creep according to claim 1, wherein said overall measurement time is continuous.

3. The sensor apparatus for determining a deformation due to creep according to claim 1, said sensor apparatus comprising:
calibrating means arranged for:
applying a predetermined mechanical force to said sensor;
measuring, by said sensor, said applied force over time;
determining and providing, by said processor component, said creep function based on a direct relation between said predetermined mechanical force and said measured applied force over time.

4. The sensor apparatus according to claim 1, wherein said creep function is an exponential function.

5. The sensor apparatus according to claim 1, wherein said processor component is further arranged for:
initially determining said deformation due to creep for a first measurement by said sensor component by:
providing said creep function, wherein said creep function defines said deformation due to creep over time;
a time between:
a start of said applying said mechanical force to said sensor, and
said first measurement by said sensor.

6. The sensor apparatus according to claim 1, wherein said sensor is further arranged for measuring, in said next measurement, said applied force, wherein said sensor apparatus further comprises:
correcting means arranged for correcting said measured applied force by taking into account said calculated deformation due to creep.

7. A sensor apparatus for determining an applied mechanical force using an output of a sensor which is measuring said applied mechanical force in which said sensor is exposed to a drifting error, said sensor apparatus comprising a sensor and a processor component, wherein said sensor apparatus is arranged for:
measuring, in a first measurement, by said sensor of said sensor apparatus, said applied force when no force is applied;
nulling, by a processor component comprised by said sensor apparatus, said measured applied force in said first measurement;
applying a mechanical force to said sensor;
measuring, in a second measurement, by said sensor by said sensor apparatus, said applied force;
stop applying said mechanical force to said sensor;
measuring, in a third measurement, by said sensor, said applied force when no force is applied to said sensor;
nulling, by said processor component, said measured applied force in said third measurement, therewith obtaining a drifting error that occurred between said first and third measurement;
correcting said second measurement by an interpolated value, said interpolated value being provided by interpolating, by said processor component, the obtained drifting error between said first measurement and said third measurement for said second measurement.

8. The sensor apparatus for determining an applied mechanical force to a sensor according to claim 7, wherein said processor component is arranged for linearly interpolating between said first measurement and said third measurement.

9. A bond tester apparatus for determining a deformation due to creep in testing a strength of a bond and/or a material, said bond tester apparatus comprising a sensor apparatus according to claim 1.

10. A method of determining a deformation due to creep in an output of a sensor, comprised by a sensor apparatus, which sensor is measuring a mechanical force, said method comprising the steps of:
applying a mechanical force to said sensor;
measuring, in a current measurement, by said sensor, a displacement of said sensor caused by said applied force;
determining, by a processor component comprised by said sensor apparatus, said deformation due to creep for a next measurement by said sensor, by:
providing a creep function, wherein said creep function defines said deformation due to creep over time;
calculating said deformation due to creep for a next measurement, based on:
said creep function;
a time between:
said current measurement of said sensor, and
said next measurement;
wherein said time between said current and said next measurement is a small portion of an overall measurement time;
said measured applied force in said current measurement;
a deformation due to creep in said current measurement.

11. The method of determining a deformation due to creep according to claim 10, wherein said overall measurement time is continuous.

12. The method of determining a deformation due to creep according to claim 10, wherein said step of providing said creep function comprises:
applying, to said sensor, a predetermined mechanical force;
measuring, by said sensor, said applied force over time;
determining and providing, by said processor component, said creep function based on a direct relation between said predetermined mechanical force and said measured applied force over time.

13. The method for determining a deformation due to creep according to claim 10, wherein said creep function is an exponential function.

14. The method for determining a deformation due to creep according to wherein said method further comprises the initial steps of:
determining, by said processor component, said deformation due to creep for a first measurement by said sensor by:
providing said creep function, wherein said creep function defines said deformation due to creep over time;
a time between:
a start of said applying said mechanical force to said sensor, and
said first measurement by said sensor.

15. The method of determining a deformation due to creep according to claim 14, wherein said creep function is dependent on said mechanical force applied at said start.

16. The method of determining a deformation due to creep according to claim 15, wherein said creep function is directly proportionally dependent on said mechanical force applied at said start.

17. The method of determining a deformation due to creep according to claim 10, wherein said method further comprises the steps of:
measuring, in said next measurement, by said sensor, said applied force;
correcting said measured applied force by taking into account said calculated deformation due to creep.

18. A method for determining an applied mechanical force using an output of a sensor which is measuring said applied mechanical force and in which is said sensor is exposed to a drifting error, said method being performed by a sensor apparatus, said method comprising the subsequent steps of:
measuring, in a first measurement, by said sensor of said sensor apparatus, said applied force when no force is applied;
nulling, by a processor component comprised by said sensor apparatus, said measured applied force in said first measurement;
applying a mechanical force to said sensor;
measuring, in a second measurement, by said sensor by said sensor apparatus, said applied force;
stop applying said mechanical force to said sensor;
measuring, in a third measurement, by said sensor, said applied force when no force is applied to said sensor;
nulling, by said processor component, said measured applied force in said third measurement, therewith obtaining a drifting error that occurred between said first and third measurement;
correcting said second measurement by an interpolated value, said interpolated value being provided by interpolating, by said processor component, the obtained drifting error between said first measurement and said third measurement for said second measurement.

19. The method for determining an applied mechanical force according to claim 18, wherein said step of interpolating comprises:
linearly interpolating between said first measurement and said third measurement.

20. The method according to claim 10, wherein said method is performed by a bond tester apparatus for determining a strength of a bond and/or a material.
